(19) United States
(12) Patent Application Publication
(10) Pub. No.: US 2024/0074401 A1
(43) Pub. Date: Mar. 7, 2024

(54) ANIMAL MILKING CLAWS AND METHODS OF USE

(71) Applicant: MADERO DAIRY SYSTEMS, INC., HOUSTON, TX (US)

(72) Inventor: PEDRO G. MADERO, SPRING, TX (US)

(73) Assignee: MADERO DAIRY SYSTEMS, INC., HOUSTON, TX (US)

(21) Appl. No.: 17/929,935

(22) Filed: Sep. 6, 2022

(51) Int. Cl. A01J 5/04; A01J 5/10

(52) U.S. Cl. CPC A01J 5/041; A01J 5/10

(57) ABSTRACT

Animal milking claws, assemblies, and methods of making and using same. Upper and lower claw portions, the upper claw portion having front and rear milk inlets, and the lower claw portion including a milk outlet. Milk inlets positioned generally tangentially to the upper claw portion force milk to flow on geodesic curves on the internal surface of the upper milk claw. Milk is forced to impact upon the vertical partition in the lower claw portion. The milk outlet has a reinforced portion extending at least a portion of a length of the milk outlet, with one or more reinforcing chamfers where the reinforced portion connects with the lower claw portion. Coolant for heat transfer may be provided to the milk outlet or the lower claw portion, or both.

### BACKGROUND INFORMATION

### Technical Field

The present disclosure relates generally to dairy equipment, and more particularly to milking claws for milking animals, such as cows and goats.

### Background Art

In general, milking claws typically include a claw top including a pair of front inlets and a pair of rear inlets. Certain embodiments include an outlet in a claw bottom, while others include a claw outlet in the claw top. Typically, the pair of front inlets are disposed on a top surface of the claw top and configured to draw milk into the claw top. The pair of front inlets may extend upwardly from the top surface of the claw top and are inclined towards a front half of the claw top. The pair of rear inlets are typically disposed on the top surface of the claw top and configured to draw milk into the claw top, extending upwardly from the top surface of the claw top and inclined towards a rear half of the claw top. The outlet is typically disposed at the rear half of the claw top or claw bottom. In some embodiments, a claw bottom may include a dividing wall configured to keep milk directed from the inlets spaced on opposite sides of a longitudinal axis of the milking claw from intermingling. The intermingling of the milk may cause splashing within the milking claw which would agitate the milk and break down the fatty globules in the milk which would otherwise cause the degradation of the milk.

One goal of milking animals in general is to provide as much comfort to the animal as possible during all stages of its life, and particularly during milking. Any added weight to the claw would generally be viewed as unwanted and a deterrent to this goal. Animal milking claws that have any unnecessary structural components or component thicknesses are therefore generally viewed as undesirable.

Despite the apparent convenience and animal comfort provided by known milking claws, problems remain. Efforts to reduce weight of milking claws may result in certain structural features not being strong enough to withstand varied, repeated movements produced by the animals, the milking machinery, and/or milking technicians. These disadvantages may cause frequent maintenance headaches, and in the worse case downtime for extended periods. Maintenance and replacement of known milking claws, drainage conduits, and drains may take away time that otherwise could be used in milking. Moreover, none of the known milking claws have any provision for cooling the obtained milk while the milk is in the claw itself. Any cooling of the milk in the milking claw would be beneficial in reducing cooling demand of downstream refrigerators and milk pre-coolers.

It would be advantageous to provide animal milking claws employing structural features that are able to withstand repeated movements of the animals and the milking machinery, while reducing labor, capital expense, and operating expenses compared with presently available systems, and which may significantly reduce maintenance issues. As may be seen, current milking claws may not be economical in all circumstances, and may result in one or more deficiencies as noted above. There remains a need for animal milking claws that are sturdy, easy to use, that are less susceptible to maintenance or replacement issues, and that may be used with a variety of metal and plastic pulsation blocks, such as side-to-side, front to back, and the like. The animal milking claws of the present disclosure are directed to these needs.

### SUMMARY

In accordance with the present disclosure, animal milking claws are described which reduce or overcome many of the faults of previously known milking claws and methods of using them, while providing high volume flow rates of milk from the animals.

A first aspect of the disclosure are animal milking claws comprising (or consisting essentially of, or consisting of):
a) an upper claw portion having an internal surface, and a lower claw portion, the upper claw portion having a first rear milk inlet, a second rear milk inlet, a first front milk inlet, a second front milk inlet, and the lower claw portion having a milk outlet and a vertical partition positioned along a longitudinal axis of the lower claw portion; b) the milk inlets positioned generally tangentially to the upper claw portion and configured so that milk flows on geodesic curves on the internal surface of the upper milk claw, and the milk is forced to impact upon the vertical partition in the lower claw portion.

In certain embodiments the animal milking claws may comprise the milk outlet having a reinforced portion adjacent a location where the milk outlet connects to the lower claw portion and extending at least a portion of a length of the milk outlet, with one or more reinforcing chamfers positioned on each location where the reinforced portion of milk outlet connects with the lower claw portion. In certain embodiments the animal milking claws may comprise
a) the first rear milk inlet having a reinforced portion adjacent a location where the first rear milk inlet connects to the upper claw portion and extending at least a portion of a length of the first rear milk inlet;
b) the second rear milk inlet having a reinforced portion adjacent a location where the second rear milk inlet connects to the upper claw portion and extending at least a portion of a length of the second rear milk inlet;
c) the first front milk inlet having a reinforced portion adjacent a location where the first front milk inlet connects to the upper claw portion and extending at least a portion of a length of the first front milk inlet; and
d) the second front milk inlet having a reinforced portion adjacent a location where the second front milk inlet connects to the upper claw portion and extending at least a portion of a length of the second front milk inlet.

In certain embodiments the animal milking claws may comprise an upper claw portion and a lower claw portion, the upper claw portion having a first rear milk inlet, a second rear milk inlet, a first front milk inlet, a second front milk inlet, and the lower claw portion having a milk outlet, the upper and lower claw portions comprising shaped plastic, mating halves of a generally spherical or other arcuate shaped milking claw. In certain embodiments the animal milking claw assemblies of the present disclosure may comprise, in addition to a milking claw as defined herein, a plastic (preferably glass fiber-filled polycarbonate (machined, molded, printed, or otherwise formed)) pulsation block connected to the upper claw portion, the plastic pulsation block having a first vacuum source connection, a second vacuum source connection, a first teat vacuum connection, a second teat vacuum connection, a third teat vacuum connection, and a fourth teat vacuum connection, the first and second teat vacuum connections positioned on a first side of the plastic pulsation block, the third and fourth teat vacuum connections positioned on a second side of the plastic pulsation block, the first, second, third, and fourth teat vacuum connections positioned in a plane, the first and second vacuum source connections positioned on a first end of the plastic pulsation block and also located in the plane. In certain embodiments the animal milking claws may comprise the milk outlet having a reinforced portion adjacent a location where the milk outlet connects to the lower claw portion and extending at least a portion of a length of the milk outlet, with one or more reinforcing chamfers positioned on each location where the reinforced portion of the milk outlet connects with the lower claw portion.

In certain embodiments the animal milking claws may comprise the lower claw portion including an external girder having a distal end and reinforcing chamfers positioned on each side of the girder where the girder meets the lower claw portion, the distal end of the girder mating with a girder alignment clip. In certain embodiments the lower milking claw portion may include an internal lip extending from the milk outlet towards the center of the milking claw and generally parallel to the milk outlet. In certain embodiments, the milking claws may comprise a main gasket between flange halves of the lower claw portion and the upper claw portion, respectively, and a central connector of the upper claw portion, the central connector having a through bore. In certain embodiments the milking claws may comprise a partition in the lower claw portion, and a central connector of lower claw portion, the central connector having a through bore, with a connecting rod positioned within the through bore. In certain embodiments the animal milking claws may comprise a rubber bumper secured to a bottom of the lower claw portion, while certain other embodiments may comprise a metal cap secured to a bottom of the lower claw portion.

Certain milking claw embodiments may feature a milk coolant feature. In certain milking claw embodiments the milk coolant feature may comprise a coolant conduit having a coolant fluid inlet and a coolant fluid outlet, the coolant conduit positioned in close heat transfer contact with an exterior surface of a lower portion of the milk outlet conduit and in spiral flow heat transfer contact with an exterior surface of the lower claw portion. Other coolant flow arrangements are possible, such as dedicated coolant flow channels formed in the milk outlet conduit, and/or the lower milking claw.

As used herein “animal” refers primarily to cows, goats, sheep, and camels, although conceivably the milking claws and milking claw assemblies described herein could be scaled up for larger animal use or down for smaller animal use. “Milking claw” means the upper and lower claw portions (either fixed together or in a kit of separated upper and lower components), while “milking claw assembly” means a milking claw including a pulsation block and other accessories described herein. “Milking cluster” refers to an assembly including a milking claw assembly, teat cups and teat cup liners, and hoses connecting the teat cups with the pulsation block, and optionally hoses connecting the teat cups to a vacuum source. “Plastic” means polymeric, filled or unfilled with one or more fillers, whether active or passive fillers. “Plastic-coated” means the component may comprise a metal core with a plastic material coated or layered thereon.

In certain embodiments the shaped plastic milking claw upper and lower halves may be formed by a procedure selected from one or more subtractive processes, one or more additive processes, one or more molding processes (for example, but not limited to, injection molding extrusion, rotational molding, and blow molding), or a combination thereof. In certain embodiments the shaped plastic milking claw upper and lower halves may be a transparent or partially transparent plastic.

These and other features of the animal milking claws, assemblies, and methods of making and using same of the present disclosure will become more apparent upon review of the brief description of the drawings, the detailed description, and the claims that follow.

### BRIEF DESCRIPTION OF THE DRAWINGS

The manner in which the objectives of this disclosure and other desirable characteristics can be obtained is explained in the following description and attached drawings in which:

FIG. 1 is a schematic perspective view of one milking claw assembly embodiment in accordance with the present disclosure, with the lower milking claw portion illustrated on top and the upper milking claw portion illustrated on the bottom;

FIG. 2 is a rear elevation view of the embodiment of FIG. 1;

FIGS. 3A and 3B are schematic perspective and side elevation detail views of the lower milking claw portion of the embodiment of FIGS. 1 and 2, and FIGS. 3C and 3D are schematic perspective views of the upper milking claw portion of the embodiment of FIGS. 1 and 2, FIG. 3D being a detailed view.

FIG. 4A is a schematic perspective view of another milking claw assembly embodiment of the present disclosure, and FIG. 4B is a schematic perspective view of one plastic pulsation block useful in certain milking claw assemblies of the present disclosure;

FIG. 5A is a perspective view of the embodiment of FIGS. 1 and 2, with some parts illustrated in phantom, and FIGS. 5B and 5C are side cross-sectional and exploded views, respectively;

FIG. 6A is a perspective view of another milking claw assembly embodiment of the present disclosure, with some parts illustrated in phantom, and FIGS. 6B and 6C are side cross-sectional and exploded views, respectively;

FIG. 7A is a perspective view of another milking claw assembly embodiment of the present disclosure, with some parts illustrated in phantom, FIGS. 7B and 7C are side cross-sectional and exploded views, respectively, and FIG. 7D is a perspective view of one pulsation block useful in this embodiment;

FIG. 8A is a perspective view of another milking claw assembly embodiment of the present disclosure, with some parts illustrated in phantom, FIGS. 8B and 8C are side cross-sectional and exploded views, respectively, and FIG. 8D is a perspective view of one pulsation block useful in this embodiment;

FIG. 9A is a perspective view of another milking claw assembly embodiment of the present disclosure, with some parts illustrated in phantom, and FIGS. 9B and 9C are side cross-sectional and exploded views, respectively;

FIG. 10A is a perspective view of another milking claw assembly embodiment of the present disclosure, with some parts illustrated in phantom, FIGS. 10B and 10C are side cross-sectional and exploded views, respectively, and FIG. 10D is a perspective view of one pulsation block useful in this embodiment; and

FIG. 11 is a logic diagram of one method of using the milking claws of the present disclosure.

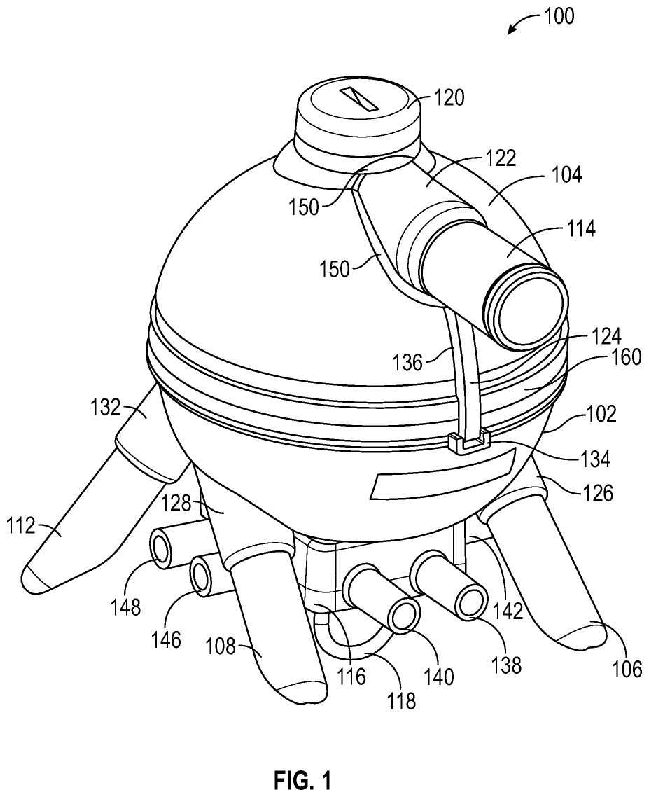

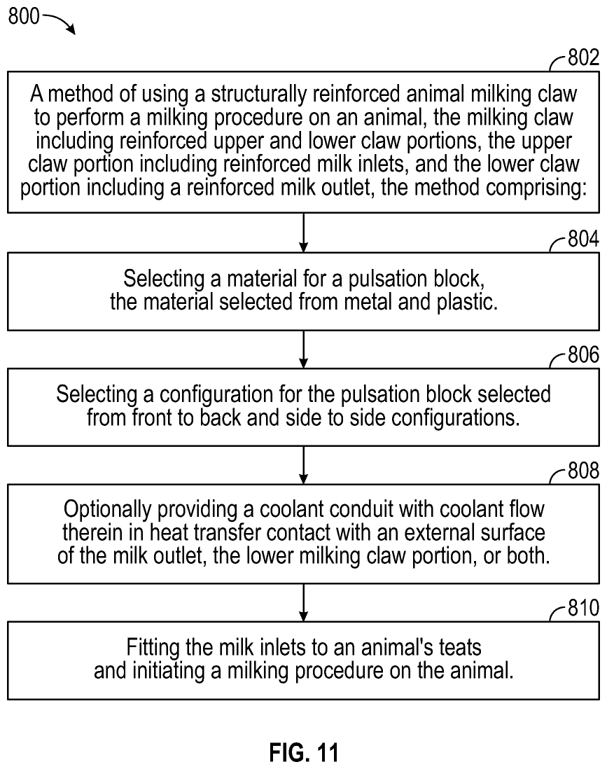

It is to be noted, however, that the appended drawings of FIGS. 1-10 are not to scale, are schematic in nature, and illustrate only typical apparatus embodiments of this disclosure, and FIG. 11 illustrates but one possible method of the present disclosure. Therefore, the drawing figures are not to be considered limiting in scope, for the disclosure may admit to other equally effective embodiments. Identical reference numerals are used throughout the several views for like or similar elements.

### DETAILED DESCRIPTION

In the following description, numerous details are set forth to provide an understanding of the animal milking claws and methods of making and using them of the present disclosure. However, it will be understood by those skilled in the art that the apparatus and methods disclosed herein may be practiced without these details and that numerous variations or modifications from the described embodiments may be possible. All technical articles, U.S. published and non-published patent applications, standards, U.S. patents, U.S. statutes and regulations referenced herein are hereby explicitly incorporated herein by reference, irrespective of the page, paragraph, or section in which they are referenced. Where a range of values describes a parameter, all sub-ranges, point values and endpoints within that range or defining a range are explicitly disclosed herein. All percentages herein are by weight unless otherwise noted.

All numbers disclosed herein are approximate values, regardless whether the word “about” or “approximate” is used in connection therewith. They may vary by 1%, 2%, 5%, and sometimes, 10 to 20%. Whenever a numerical range with a lower limit, RL and an upper limit, RU, is disclosed, any number falling within the range is specifically disclosed. In particular, the following numbers within the range are specifically disclosed: R=RL+k*(RU−RL), wherein k is a variable ranging from 1% to 100% with a 1% increment, i.e., k is 1%, 2%, 3%, 4%, 5%, . . . , 50%, 51%, 52%, . . . 95%, 96%, 97%, 98%, 99%, or 100%. Moreover, any numerical range defined by two R numbers as defined in the above is also specifically disclosed.

It should be understood that wherever the term “comprising” is used herein, other embodiments where the term “comprising” is substituted with “consisting essentially of” are explicitly disclosed herein, and vice versa. It should be further understood that wherever the term “comprising” is used herein, other embodiments where the term “comprising” is substituted with “consisting of” are explicitly disclosed herein, and vice versa. Moreover, the use of negative limitations is specifically contemplated; for example, certain animal milking claws may include metal pulsation blocks, while other embodiments may be devoid of metal pulsation blocks. In certain embodiments the plastics used in constructing the animal milking claws may be devoid of fillers. In certain embodiments the upper and lower milking claw portions may be devoid of metal. The term “comprising” and derivatives thereof is not intended to exclude the presence of any additional component, step or procedure, whether or not the same is disclosed herein. In order to avoid any doubt, all systems, processes, and compositions claimed herein through use of the term “comprising” may include any additional component, step, additive, adjuvant, or compound whether monomeric, oligomeric, polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

As mentioned herein, despite the apparent convenience of known animal milking claws, problems remain. There remains a need for animal milking claws that provide faster milking while maintaining healthier teats, greater flow capacity, allow and handle good vacuum stability even at greater flow capacity, are structurally reinforced, more durable, yet easy to use and maneuverable, and flexible in construction to employ a variety of metal and plastic pulsaton blocks and configurations of vacuum source inlets and vacuum conduits for front and rear teats. The animal milking claws of the present disclosure are directed to these needs. In certain embodiments, milking claws of the present disclosure are capable of volume flow rates of milk from cows ranging from about 40 to about 50 ml/squeeze/side, and from about 15 to about 25 ml/squeeze/teat (or from about 18 to about 22 ml/squeeze/teat).

In certain embodiments (or portions thereof) the animal milking claws of the present disclosure may be formed by a procedure selected from one or more subtractive processes, one or more additive processes, one or more molding processes (for example, but not limited to, injection molding extrusion, rotational molding, and blow molding), or a combination thereof.

The one or more substractive processes may be selected from machining operations such as cutting, sanding, knurling, drilling, deformation, facing, and turning, all of which may be computer-aided or non-computer-aided.

The one or more additive processes may be selected from rapid prototyping, 3D printing, stereolithography (SLA) printing, near-net or net-shape casting, and combinations thereof.

In certain embodiments, the upper and lower milking claw portions and plastic pulsation block may comprise the same or different plastic homopolymer, a plastic copolymer, mixtures thereof, and layered versions thereof, wherein the plastic homopolymer may be unfilled or partially filled with one or more fillers, wherein the plastic copolymer may be unfilled or partially filled with one or more fillers, wherein the filler may be selected from fibrous materials, non-fibrous materials, and mixtures thereof.

In certain embodiments the plastic pulsation block may be a glass fiber reinforced polycarbonate having properties described in Table 1. These specific polycarbonates are known under the trade designation Panlite® polycarbonate, commercially available from Teijin.

TABLE 1
Properties of Glass Fiber Reinforced Polycarbonate known unde
the trade designation Panlite ® GN-3410R

| | Metric | English | Cmments |
|---|---|---|---|
| Physical Property | | | |
| Density | 1.27 g/cc | 0.0459 lb/in3 | ISO 1183 |
| Moisture Absorption | 0.160% | 0.160% | ISO 62 |
| | @Temperature 23.0° C., | @Temperature 73.4° F., | |
| | Time 86400 sec | Time 24.0 hour | |
| Linear Mold Shrinkage, | 0.0030-0.0050 cm/cm | 0.0030-0.0050 in/in | Teijin method |
| Flow | @Thickness 4.00 mm | @Thickness 0.157 in | |
| Linear Mold Shrinkage, | 0.0040-0.0060 cm/cm | 0.0040-0.0060 in/in | Teijin method |
| Tansverse | @Thickness 4.00 mm | @Thickness 0.157 in | |
| Mechanical Properties | | | |
| Tensile Strength at Break | 70.0 MPa | 10200 psi | ISO 527-2/5 |
| Elongation at Break | 3.5% | 3.5% | ISO 527-2/5 |
| Tensile Modulus | 3.70 GPa | 537 ksi | ISO 527-2/1 |
| Flexural Strength | 120 MPa | 17400 psi | 2.0 mm/min; ISO 178 |
| Flexural Modulus | 3.60 GPa | 522 ksi | 2.0 mm/min; ISO 178 |
| Charpy Impact Unnotched | 5.50 J/cm² | 26.2 ft-lb/in² | ISO 179 |
| Charpy Impact, Notched | 1.00 J/cm² | 4.76 ft-lb/in² | ISO 179 |
| Electrical Properties | | | |
| Volume Resistivity | >=1.00e+15 ohm-cm | >=1.00e+15 ohm-cm | IEC 60093 |
| Surface Resistance | >=1.00e+15 ohm | >=1.00e+15 ohm | IEC 60093 |
| Dielectric Constant | 3.2 | 3.2 | IEC 60250 |
| | @Frequency 100 Hz | @Frequency 100 Hz | |
| | 3.2 | 3.2 | IEC 60250 |
| | @Frequency 1.00e+6 Hz | @Frequency 1.00e+6 Hz | |
| Dielectric Strength | 35.0 kV/mm | 889 kV/in | short time test; IEC 60243-1 |
| Dissipation Factor | 0.0010 | 0.0010 | IEC 60250 |
| | @Frequency 100 Hz | @Frequency 100 Hz | |
| | 0.0090 | 0.0090 | IEC 60250 |
| | @Frequency 1.00e+6 Hz | @Frequency 1.00e+6 Hz | |
| Comparative Tracking | 175 V | 175 V | IEC 60112 |
| Index | | | |
| Thermal Properties | | | |
| CTE, linear, Parallel to | 40.0 μm/m-° C. | 22.2 μin/in-° F. | ISO 11359-2 |
| Flow | | | |
| CTE, linear, Transverse to | 60.0 μm/m-° C. | 33.3 μin/in-° F. | ISO 11359-2 |
| Flow | | | |
| Deflection Temperature at | 149° C. | 300° F. | unannealed; ISO 75-2/B |
| 0.46 MPa (66 psi) | | | |
| Deflection Temperature at | 144° C. | 291° F. | unannealed; ISO 75-2/A |
| 1.8 MPa (264 psi) | | | |
| Vicat Softening Point | 151° C. | 304° F. | ISO 306/B50 |
| UL RTI, Electrical | 130° C. | 266° F. | UL 746 |
| | @Thickness 1.50 mm | @Thickness 0.0591 in | |
| UL RTI, Mechanical with | 120° C. | 248° F. | UL 746 |
| Impact | @Thickness 1.50 mm | @Thickness 0.0591 in | |
| UL RTI, Mechanical | 130° C. | 266° F. | UL 746 |
| without Impact | @Thickness 1.50 mm | @Thickness 0.0591 in | |
| Flammability, UL94 | HB | HB | |
| | @Thickness 0.430 mm | @Thickness 0.0169 in | |
| | V-2 | V-2 | |
| | @Thickness 0.800 mm | @Thickness 0.0315 in | |
| | V-1 | V-1 | |
| | @Thickness 3.00 mm | @Thickness 0.118 in | |

Other polycarbonates useful in plastic pulsation blocks may be aliphatic or aromatic polycarbonates, branched chain polycarbonates, and copolymers with other monomers. For example, to enhance flame retardancy, without use of additives, 2,2-bis-(3,5-dibromo-4-hydroxyphenyl)propane (tetrabromobis-phenol A) has been used in copolymers with bis-phenol A. To enhance referactive index copolymers of bis-phenol S (thiodiphenol) with bis-phenol A have been employed. The refractive index of the copolymer nₒ is 1.610 compared with 1.590 for the homopolymer. To reduce melt viscosity an aliphatic dicarboxylic acid may be used to partially replace the carbonic acid derivative. Easy-flow grades with a melt flow rate of 80 are available. Such an improvement in flow rate is, however, at the expense of heat distortion temperature. To enhance the resistance to heat softening bis-phenol A may be substituted by a stiffer molecule. Conventional bis-phenol A polycarbonates have lower heat distortion temperatures (deflection temperatures under load) than some of the somewhat newer aromatic thermoplastics, such as the polysulphones. A polycarbonate in which the bis-phenol A is replaced by tetramethylbis-phenol A has a Vicat softening point of 196° C., excellent resistance to hydrolysis, excellent resistance to tracking and a low density of about 1.1 g/cm³. Such improvements are obtained at the expense of impact strength and resistance to stress cracking. Polycarbonate homopolymers and copolymers may also be filled with solid lubricants, glass fibers, polyaramid fibers, colorants, and the like to enhance their structural, bearing and wear properties, and/or simply their appearance. Materials such as glass, PTFE, graphite and oil are all available in standard sizes.

In certain embodiments the upper and lower milking claw portions may be comprised of any of a variety of thermoplastics, such as as the above-described polycarbonates, polysulphones, polyphenylsulphones (such as those available under the trade designation Radel®, available from Solvay), polyesters, polyethers, and polyimides, and copolymers and terpolymers thereof (such as polyetherimides).

In certain embodiments the upper and lower milking claw portions may have a hemispherical or approximately hemispherical shape, or arcuate bowl shape, and for cow milking a volume of at least about 150 ml, or volume ranging from about 150 ml to about 300 ml, or from about 150 ml to about 250 ml. The thicknesses of the upper and lower milking claw portions may be the same or different, and may be uniform or nonuniform; an example of nonuniform thickness includes those where the thickness increases from the centerline locations where the upper and lower milking claw portions are connected to the locations where the milk inlet conduits connect to the upper milking claw portion. The thickness of the upper milking claw portion in the regions around the milk inlet conduits may be 25 percent, 50 percent, or 100 percent greater than the thickness at the center line of the milking claw.

The milking claw upper and lower portions may be transparent or partially transparent. In certain embodiments they may comprise a rigid transparent plastic, in addition to those already mentioned, such as for example polyethylene terephthalate (PET), polyvinyl chloride (PVC), polypropylene (PP), polystyrene (PS), polymethyl methacrylate (PMMA), polyamide, polyethylene, polytetrafluoroethylene (PTFE), copolymers, mixtures, and layered versions of two or more of these, and the like.

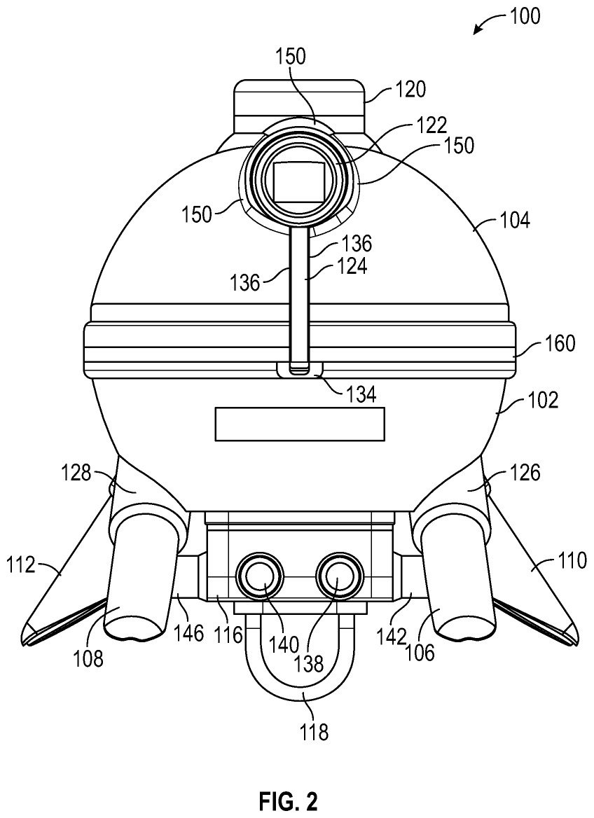

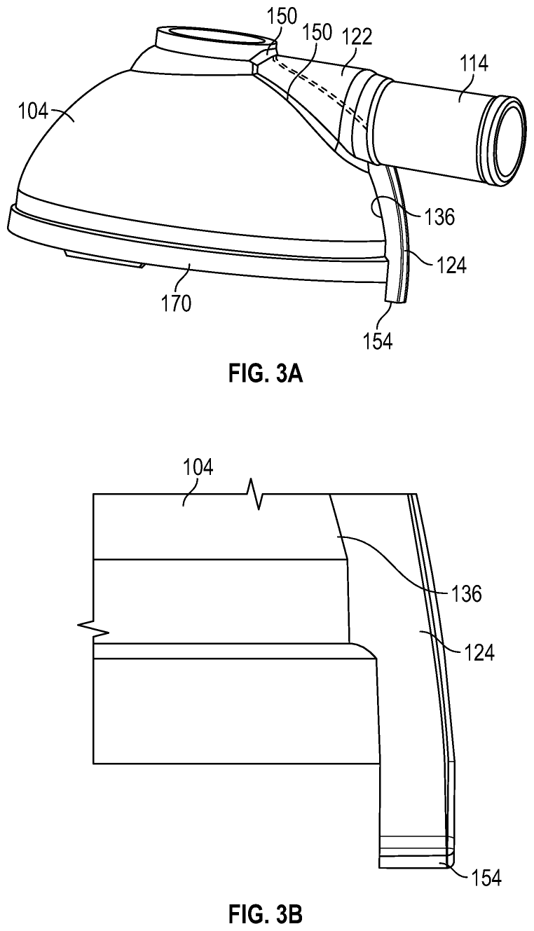

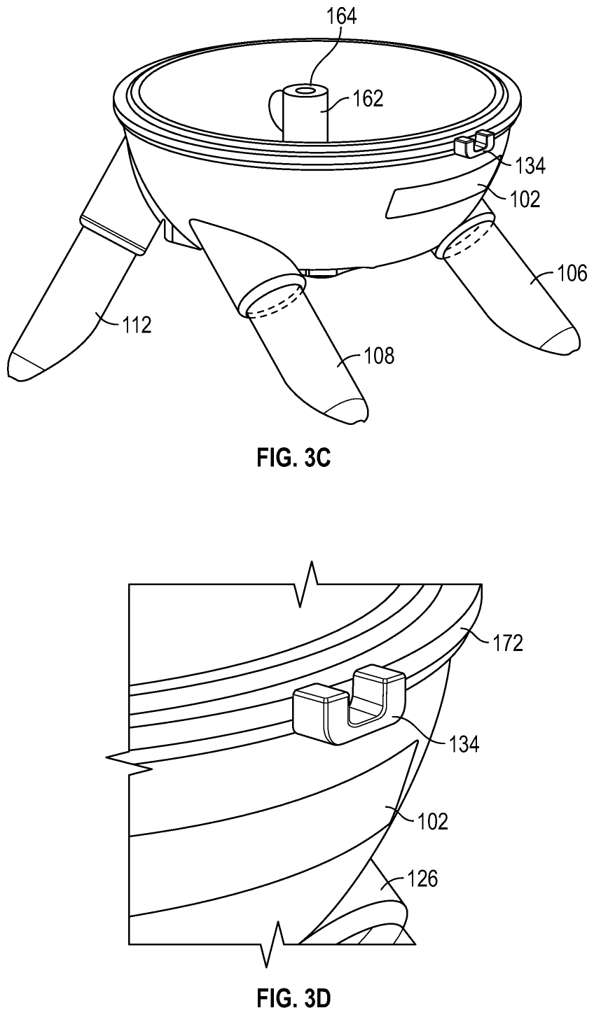

Referring now to the drawing figures, FIG. 1 is a schematic perspective view of one animal milking claw assembly embodiment 100 in accordance with the present disclosure, with the lower milking claw portion illustrated on top and the upper milking claw portion illustrated on the bottom; FIG. 2 is a rear elevation view of the embodiment of FIG. 1; FIGS. 3A and 3B are schematic perspective and side elevation detail views of the lower milking claw portion of the embodiment of FIGS. 1 and 2, and FIGS. 3C and 3D are schematic perspective views of the upper milking claw portion of the embodiment of FIGS. 1 and 2, FIG. 3D being a detailed view. An animal milking claw assembly embodiment 100 includes a milking claw having an upper generally hemispherical claw portion 102 and a lower generally hemispherical claw portion 104, the upper claw portion 102 having a first rear milk inlet 106, a second rear milk inlet 108, a first front milk inlet 110, a second front milk inlet 112, and the lower claw portion having a milk outlet 114 and an internal lip 115 extending from the milk outlet towards the center of the milking claw and generally parallel to milk outlet 114.

Embodiment 100 further includes a plastic pulsation block 116 connected to upper claw portion 102, plastic pulsation block 116 having a first vacuum source connection 138, a second vacuum source connection 140, a first teat vacuum connection 142, a second teat vacuum connection 144, a third teat vacuum connection 146, and a fourth teat vacuum connection 148, the first and second teat vacuum connections positioned on a first side of the plastic pulsation block, with the third and fourth teat vacuum connections positioned on a second side of the plastic pulsation block. The first, second, third, and fourth teat vacuum connections (142, 144, 146, and 148, respectively) are positioned in a plane in this embodiment, with the first and second vacuum source connections 138, 140 positioned on a first end of plastic pulsation block 116 and also located in the plane. Importantly, milk outlet 114 has a reinforced portion 122 adjacent a location where milk outlet 114 connects to lower claw portion 104 and extending at least a portion of a length of milk outlet 114, with one or more reinforcing chamfers 150 positioned on each location where reinforced portion 122 of milk outlet 114 connects with lower claw portion 104.

The animal milking claw of milking claw assembly embodiment 100 further comprises the first rear milk inlet 106 having a reinforced portion 126 adjacent a location where first rear milk inlet 106 connects to upper claw portion 102 and extending at least a portion of a length of first rear milk inlet 106. Second rear milk inlet 108 has a reinforced portion 128 adjacent a location where second rear milk inlet 108 connects to upper claw portion 102 and extending at least a portion of a length of second rear milk inlet 108. First front milk inlet 110 has a reinforced portion 130 adjacent a location where first front milk inlet 110 connects to upper claw portion 102 and extending at least a portion of a length of first front milk inlet 110. Finally, second front milk inlet 112 has a reinforced portion 132 adjacent a location where second front milk inlet 112 connects to upper claw portion 102 and extending at least a portion of a length of second front milk inlet 112.

Animal milking claw of milking claw assembly embodiment 100 further comprises the lower claw portion 104 including an external girder 124 having a distal end 154 and reinforcing chamfers 136 positioned on each side of external girder 124 where external girder 124 meets lower claw portion 104, distal end 154 of girder 124 mating with a girder alignment clip 134.

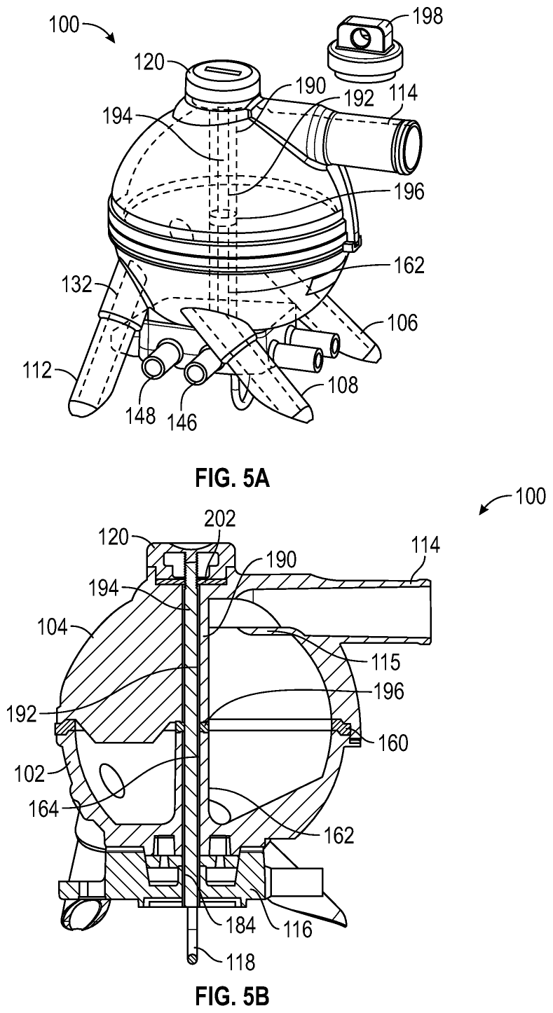

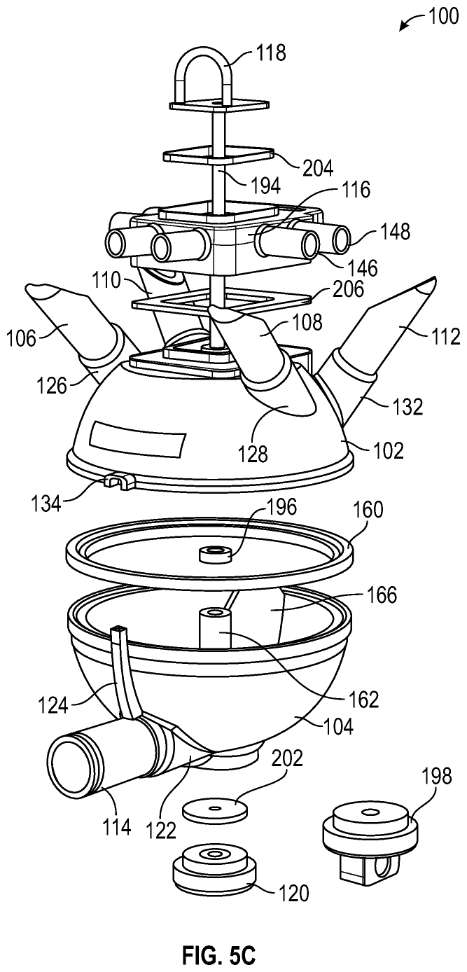

FIG. 5A is a perspective view of embodiment 100 illustrated schematically in FIGS. 1 and 2, with some parts illustrated in phantom, and FIGS. 5B and 5C are schematic side cross-sectional and exploded views, respectively. The milking claw of milking claw assembly embodiment 100 further comprises a main gasket 160 (typically natural rubber or equivalent) between flange halves 170, 172 of lower claw portion 104 and upper claw portion 102, respectively. The milking claw of assembly embodiment 100 further comprises a central connector 162 of upper claw portion 102, central connector 162 having a through bore 164. Embodiment 100 further comprises a partition 166 in lower claw portion 104, with a central connector 190, central connector 190 having a through bore 192. A connecting rod 194 is positioned within through bore 192, and a gasket 196 is positioned between central connector 190 and central connector 162 of upper claw portion 102. Suitable gasket materials include various natural and man-made rubber compounds, elastomeric compounds, thermoplastic-elastomeric compounds, and the like, with or without fillers, additives, coupling agents, and other optional additives.

The animal milking claw assemblies of the present disclosure may further comprise a rubber bumper 120 secured to a bottom of the lower claw portion 104, or in other embodiments may comprise a metal cap 198 secured to a bottom of the lower claw portion 104. When using a rubber bumper 120, a washer 202 may be positioned between the rubber bumper and a lower spout of lower claw portion 104. In certain embodiments, a rubber gasket 204 is positioned between plastic pulsation block 116 and a U-hook 118. Embodiments may further comprise a gasket 206 between plastic pulsation block 116 and upper claw portion 102. Suitable gasket and rubber bumper materials include various natural and man-made rubber compounds, elastomeric compounds, thermoplastic elastomer compounds, and the like, with or without fillers, additives, coupling agents, and other optional additives.

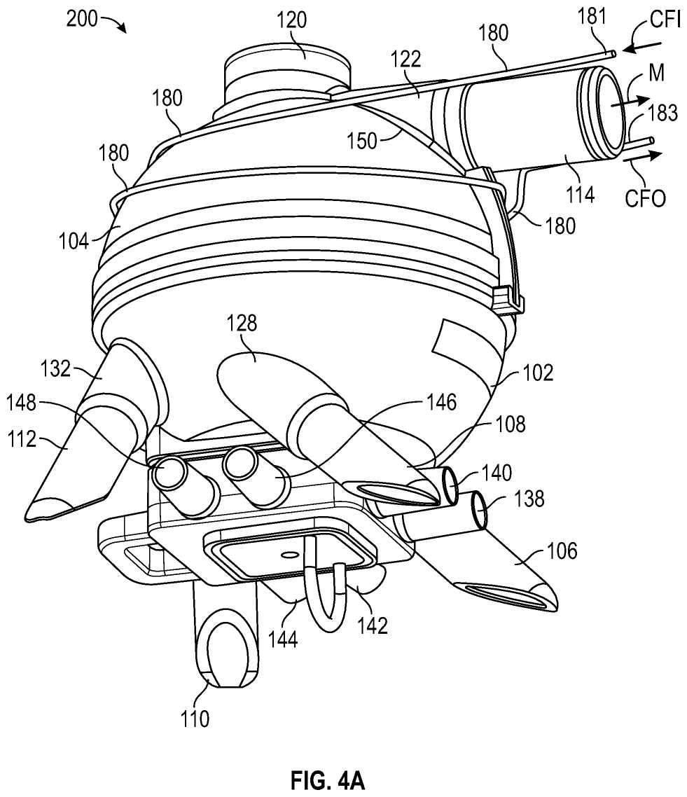

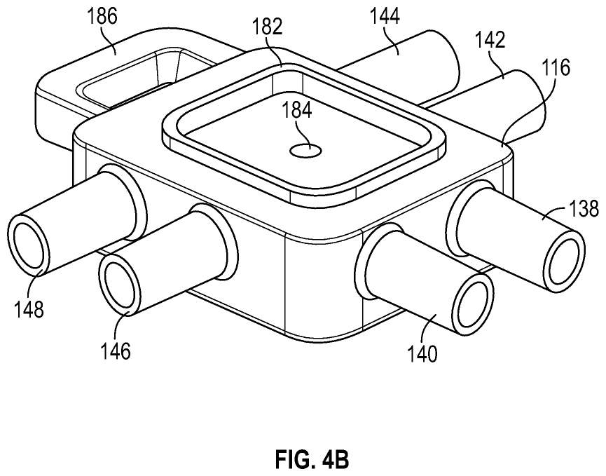

FIG. 4A is a schematic perspective view of another milking claw assembly embodiment 200 of the present disclosure, and FIG. 4B is a schematic perspective view of one plastic pulsation block useful in milking claw assemblies of the present disclosure. Embodiment 200 is similarly structured to embodiment 100, but further comprises a coolant conduit 180 having a coolant fluid inlet 181 (indicated with an arrow as “CFI” in FIG. 4A) and a coolant fluid outlet 183 (indicated with another arrow as “CFO” in FIG. 4A). Coolant conduit 180 is configured to transport a cooling fluid, typically water, therethrough for the purpose of cooling milk obtained during milking. In embodiment 200, coolant conduit 180 is positioned in close heat transfer contact with an exterior surface of a lower portion of milk outlet conduit 114 and in spiral flow heat transfer contact with an exterior surface of lower claw portion 104. As mentioned herein, other coolant flow arrangements are considered within this disclosure, including embodiments where dedicated channels are formed directly into the plastic of lower claw portion 104 and/or milk outlet 114. Cooling water may be used from an existing milk pre-chiller or refrigeration system, or a stand-alone coolant supply. Other coolants fluid may be used, such as used in mechanical air cooling systems. As used herein mechanical air cooling systems and processes are those where a refrigerant is cyclicly compressed and expanded. Where these systems may be reversed to provide heat as in heat pumps, that is specifically noted. In certain embodiments the system may include refrigerant compositions selected from CFCs, HFCs, perfluorocarbons, HFOs, and mixtures of any two or more of these. In certain embodiments the refrigerant composition may have two or more components at specific ratios of components. In certain embodiments the refrigerant composition, refrigerant conduits, and compressor may be configured to provide flow rates, temperature and pressure of refrigerant sufficient to cool milk in the milking claw lower portion and/or milk outlet from 5 to 50 degrees F., or from 5 to 20 degrees F.

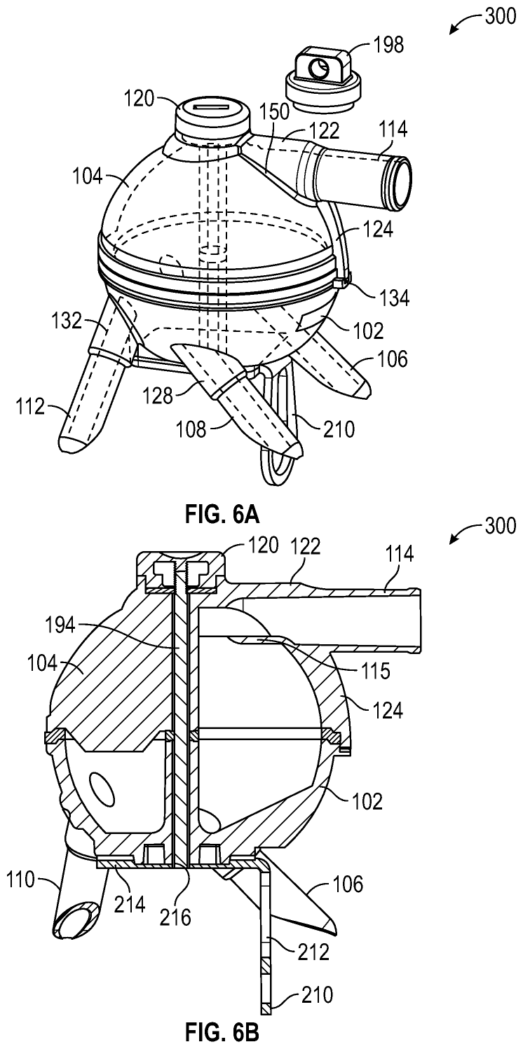

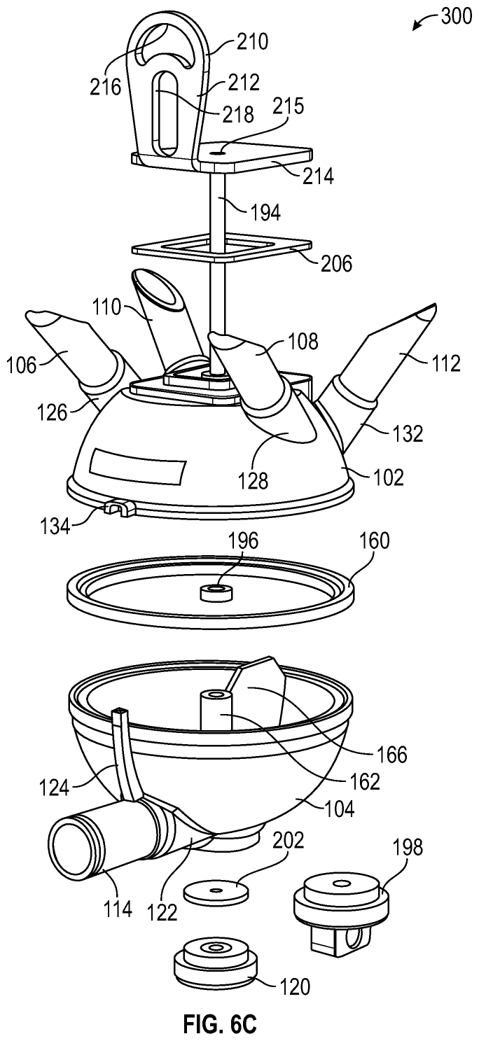

FIG. 6A is a perspective view of another milking claw assembly embodiment 300 of the present disclosure, with some parts illustrated in phantom, and FIGS. 6B and 6C are side cross-sectional and exploded views, respectively. Animal milking claw assembly embodiment 300 is similar to embodiment 100 except it does not include the plastic pulsation block. Embodiment 300 comprises a 90-degree bracket 210 having a first (vertical) leg 212, a second (horizontal) leg 214, a through bore 215 in second leg 214, an arcuate slot 216 in first leg 212, and a generally linear slot 218 in first leg 212. The 90-degree bracket is configured to secure a metal pulsation block to the upper claw portion 102. As with embodiment 100, milk outlet 114 may include a reinforced portion 122 adjacent a location where milk outlet 114 connects to lower claw portion 104 and extending at least a portion of a length of milk outlet 114, and one or more reinforcing chamfers 150 may be positioned on each location where reinforced portion 122 of milk outlet 114 connects with lower claw portion 104.

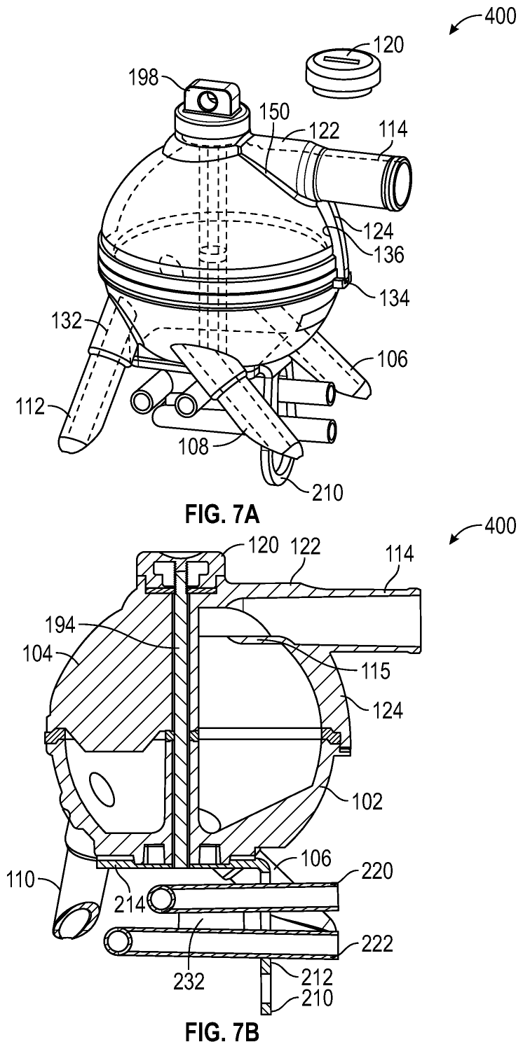

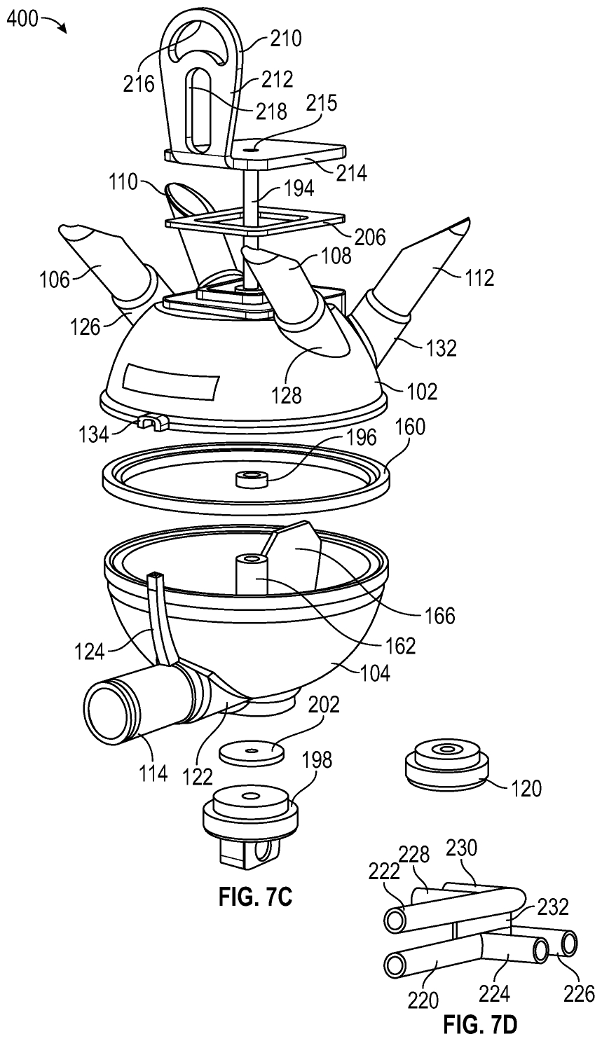

FIG. 7A is a schematic perspective view of another milking claw assembly embodiment 400 of the present disclosure, with some parts illustrated in phantom. FIGS. 7B and 7C are schematic side cross-sectional and exploded views, respectively, and FIG. 7D is a schematic perspective view of one pulsation block useful in embodiment 400. Animal milking claw assembly embodiment 400 is similar to embodiment 300, but further includes the 90-degree bracket 210 securing a metal pulsation block to the upper claw portion 102, the metal pulsation block having a first vacuum source conduit 220, a second vacuum source conduit 222, a first teat vacuum conduit 224, a second teat vacuum conduit 226, a third teat vacuum conduit 228, and a fourth teat vacuum conduit 230. In embodiment 400 the first and second teat vacuum conduits (224, 226) are fluidly connected with first vacuum source conduit 220 and positioned on a first side of the metal pulsation block in a first plane, while the third and fourth teat vacuum connections (228, 230) are fluidly connected with second vacuum source conduit 222 and positioned on a second side of the metal pulsation block in a second plane parallel to the first plane. The first and second vacuum source connections (220, 222) are positioned on a first end of the metal pulsation block located in a third plane perpendicular to the first and second planes, the first and second vacuum source connections (220, 222) extending through the generally linear slot 218, and a connecting plate 232 connecting first vacuum source conduit 220 with second vacuum source conduit 222. Similar to other embodiments, milk outlet 114 may be similarly reinforced at a reinforced portion 122 adjacent a location where milk outlet 114 connects to the lower claw portion and extending at least a portion of a length of milk outlet 114. One or more reinforcing chamfers 150 may be positioned on each location where reinforced portion 122 of milk outlet 114 connects with lower claw portion 104.

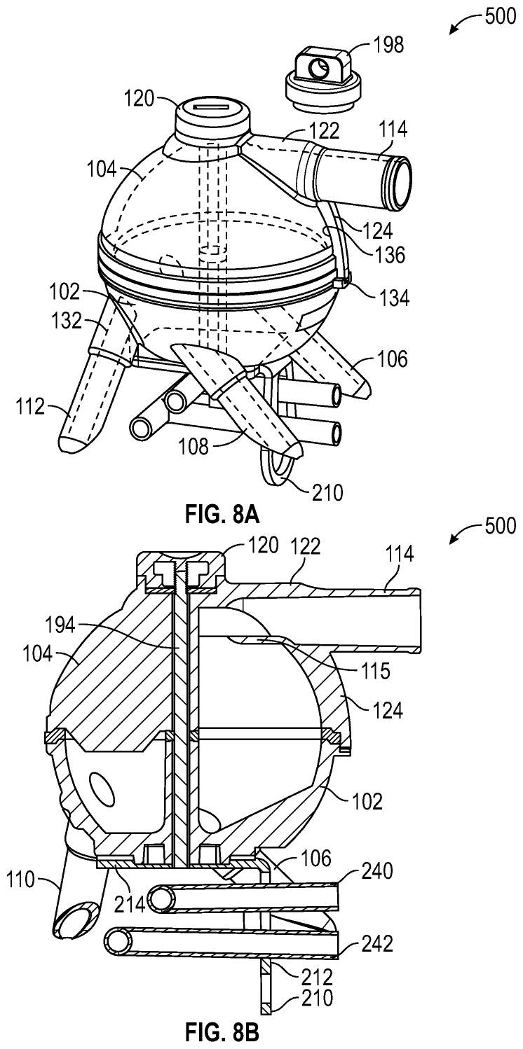

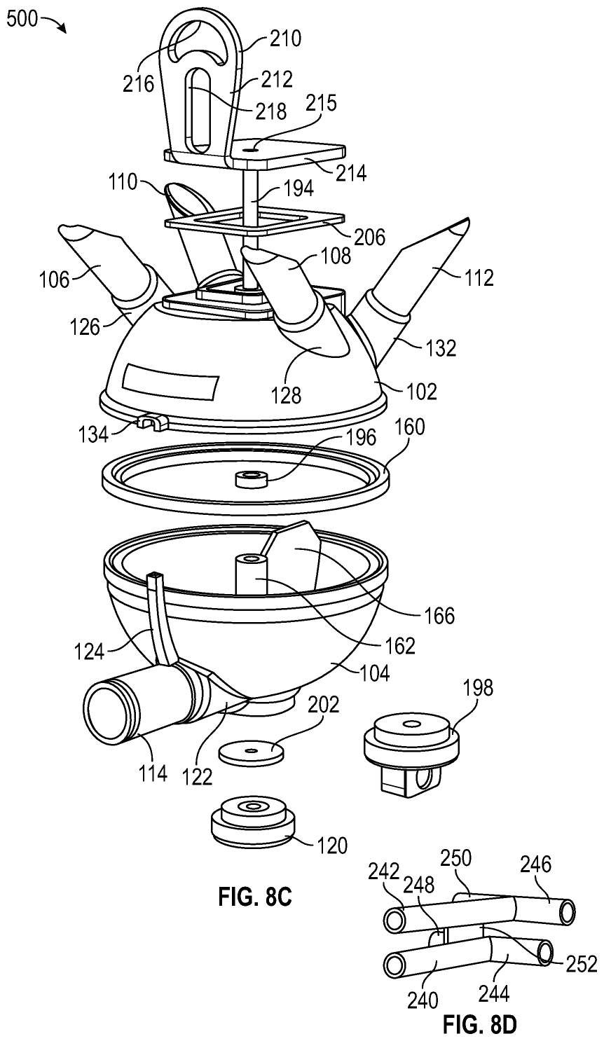

FIG. 8A is a perspective view of another milking claw assembly embodiment 500 of the present disclosure, with some parts illustrated schematically in phantom, FIGS. 8B and 8C are schematic side cross-sectional and exploded views, respectively, and FIG. 8D is a schematic perspective view of one pulsation block useful in embodiment 500. Animal milking claw assembly embodiment 500 is similar to embodiment 400 in term of reinforcement; however, in embodiment 500 the 90-degree bracket (210) secures a metal pulsation block to upper claw portion 102, the metal pulsation block having a first alternate vacuum source conduit 240, a second alternate vacuum source conduit 242, a first teat alternate vacuum conduit 244, a second teat alternate vacuum conduit 246, a third teat alternate vacuum conduit 248, and a fourth teat alternate vacuum conduit 250. In embodiment 500, the first and third teat alternate vacuum conduits (244, 248) are fluidly connected with first alternate vacuum source conduit 240 and positioned on a first side of the metal pulsation block in a first plane, while the second and fourth teat alternate vacuum connections (246, 250) are fluidly connected with second alternate vacuum source conduit (242) and positioned on a second side of the metal pulsation block in a second plane parallel to the first plane. The first and second alternate vacuum source connections (240, 242) are positioned on a first end of the metal pulsation block located in a third plane perpendicular to the first and second planes. The first and second vacuum source connections (240, 242) extend through generally linear slot 218, and a connecting plate 252 connecting first alternate vacuum source conduit 240 with second alternate vacuum source conduit 242. Milk outlet 114 may be similarly reinforced at a reinforced portion 122 adjacent a location where milk outlet 114 connects to the lower claw portion and extending at least a portion of a length of milk outlet 114. One or more reinforcing chamfers 150 may be positioned on each location where reinforced portion 122 of milk outlet 114 connects with lower claw portion 104.

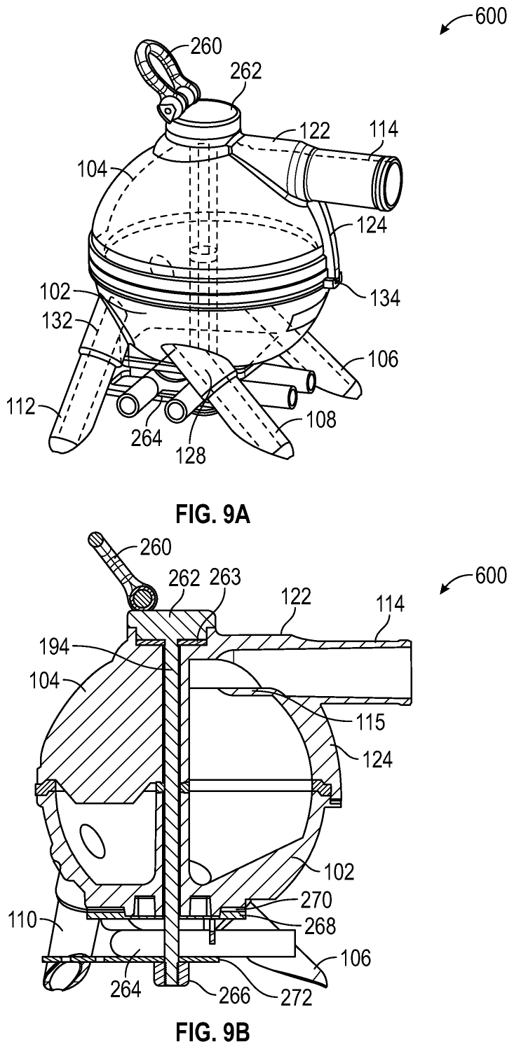

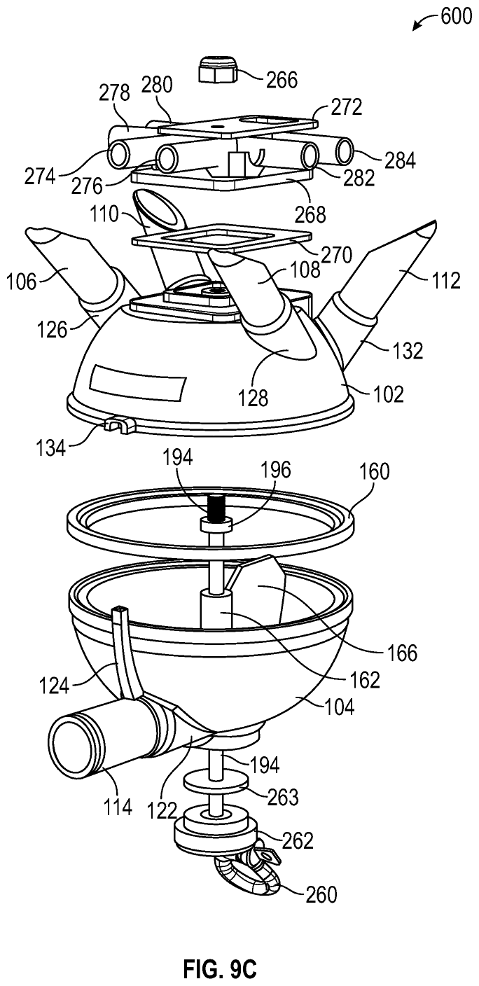

FIG. 9A is a schematic perspective view of another milking claw assembly embodiment 600 of the present disclosure, with some parts illustrated in phantom, and FIGS. 9B and 9C are schematic side cross-sectional and exploded views, respectively.

Animal milking claw assembly embodiment 600 comprises a metal pulsation block 264 connected to upper claw portion 102, metal pulsation block 264 having a first metal vacuum source connection 274, a second metal vacuum source connection 276, a first teat metal vacuum connection 278, a second teat metal vacuum connection 280, a third teat metal vacuum connection 282, and a fourth teat metal vacuum connection 284. The first and second teat metal vacuum connections (278, 280) are positioned on a first side of metal pulsation block 264, and the third and fourth teat metal vacuum connections (282, 284) are positioned on a second side of metal pulsation block 264. The first, second, third, and fourth teat metal vacuum connections (278, 280, 282, and 284) are positioned in a plane, with the first and second metal vacuum source connections (274, 276) positioned on a first end of metal pulsation block 164 and also located in the plane. Milk outlet 114 may be similarly reinforced at a reinforced portion 122 adjacent a location where milk outlet 114 connects to the lower claw portion and extending at least a portion of a length of milk outlet 114. One or more reinforcing chamfers 150 may be positioned on each location where reinforced portion 122 of milk outlet 114 connects with lower claw portion 104.

Embodiment 600 further comprises a shackle 260 connected to a metal cap 262. Metal cap 262 is integral with a metal connecting rod 194, and a nut 266 is threaded onto a distal end of metal connecting rod 194. Embodiment 600 further comprises a gasket 263 positioned between metal cap 262 and lower claw portion 104. A first metal connection plate 268 is provided for attaching metal pulsation block 264 to upper milking claw portion 102 with a gasket 270 positioned between first metal connection plate 268 and upper milking claw portion 102. A second metal connecting plate 272 parallel to and positioned in a plane spaced apart from the first metal connection plate 268 is provided and secured with nut 266.

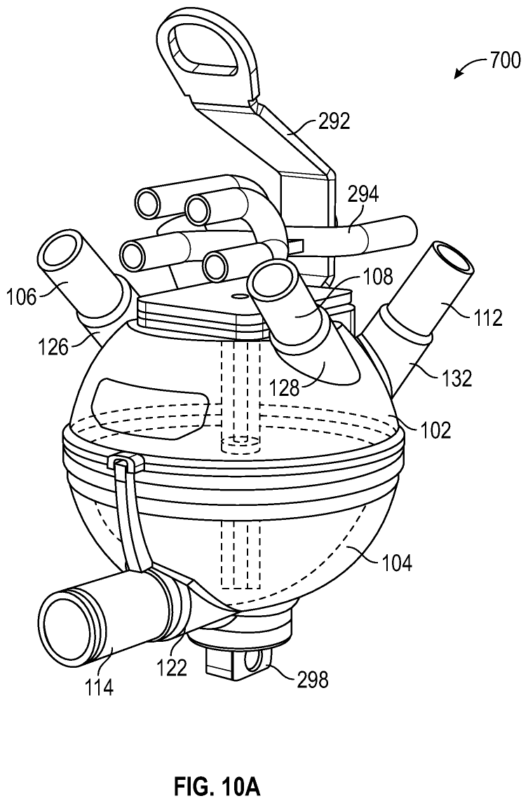

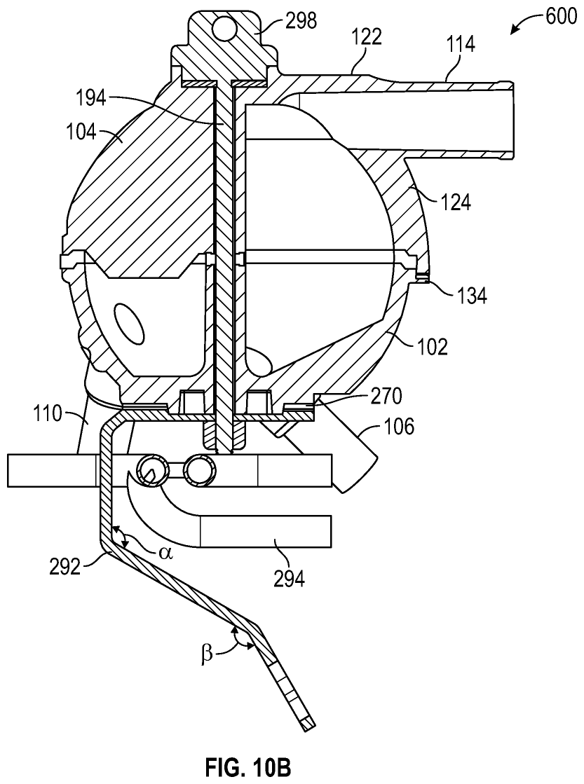

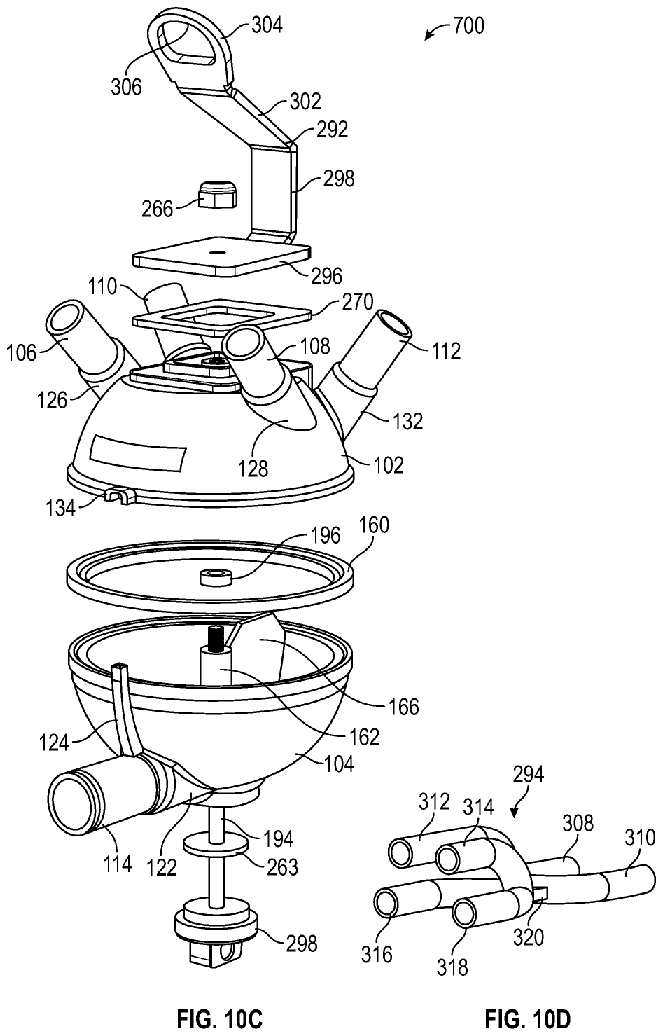

FIG. 10A is a schematic perspective view of another milking claw assembly embodiment 700 of the present disclosure, with some parts illustrated in phantom, FIGS. 10B and 10C are schematic side cross-sectional and exploded views, respectively, and FIG. 10D is a schematic perspective view of one pulsation block useful in this embodiment. Animal milking claw assembly embodiment 700 comprises a metal bracket 292 having a first portion 296, a second portion 298 connected to and generally perpendicular to first portion 296, a third portion 302 connected to second portion 298 and angled to second portion 298 at an angle α ranging from about 120 to about 160 degrees, and a fourth portion 304 connected to third portion 302 and angled to third portion 302 at an angle β ranging from about 130 to about 160 degrees, with a through hole 306 in fourth portion 304. Embodiment 700 further comprises the metal bracket 292 securing a metal pulsation block 294 to upper claw portion 102, metal pulsation block 294 having a front metal vacuum source conduit 312, a rear metal vacuum source conduit 314, a first front teat metal vacuum conduit 308, a second front teat metal vacuum conduit 310, a first rear teat metal vacuum conduit 316, and a second rear teat metal vacuum conduit 318. The first and second front teat metal vacuum conduits (308, 310) are fluidly connected with front metal vacuum source conduit 312 and form a front-facing U-shaped end of metal pulsation block 294. The first and second rear teat metal vacuum conduits (316, 318) are fluidly connected with rear metal vacuum source conduit 314 and form a rear-facing U-shaped end of metal pulsation block 294, the first and second front teat metal vacuum source connections (308, 310) extending around second portion 298 of metal bracket 292. A connecting plate 320 connects the front-facing U-shaped end with the rear-facing U-shaped end. Similar to other embodiments described herein, milk outlet 114 may be reinforced at a reinforced portion 122 adjacent a location where milk outlet 114 connects to the lower claw portion and extending at least a portion of a length of milk outlet 114. One or more reinforcing chamfers 150 may be positioned on each location where reinforced portion 122 of milk outlet 114 connects with lower claw portion 104. Embodiment 700 may further comprise a metal cap 298 integral with a metal connecting rod 194 extending through upper and lower milking claw portions (102, 104) and secured with nut 266 fastened to a distal end of metal connecting rod 194. Note that embodiment 700 lacks the internal lip extension 115. Certain customers desire embodiments without the internal lip extension in order to reduce breakup of milk clots.

FIG. 11 is a logic diagram of one method embodiment 800 of using the milking claws and assemblies of the present disclosure to perform a milking procedure on an animal, the milking claw including reinforced upper and lower claw portions, the upper claw portion including reinforced milk inlets, and the lower claw portion including a reinforced milk outlet, the method comprising (box 802) selecting a material for a pulsation block, the material selected from metal and plastic, box 804. Method embodiment 800 further comprises selecting a configuration for the pulsation block selected from front to back and side to side configurations, box 806. Method embodiment 800 further comprises optionally providing a coolant conduit with coolant flow therein in heat transfer contact with an external surface of the milk outlet, the lower milking claw portion, or both, box 808. Finally, embodiment 800 comprises fitting the milk inlets to an animal's teats and initiating a milking procedure on the animal, box 810.

A method of fabricating milking claws and assemblies and components thereof is another aspect of the present disclosure. One method embodiment comprises (a) forming components, in no particular order:
(i) upper and lower milking claw portions;
(ii) a pulsation block selected from metal and plastic, and configuration selected from side to side and front to back;
(iii) the lower milking claw portion having through-passages for coolant fluid; and;
(b) fitting components (i)-(iii) together to form a milking claw assembly;
(c) optionally fitting coolant supply and return conduits to the milking claw assembly; and
(d) fitting or attaching the upper and lower claw portions together, and fitting or attaching the pulsation block to the upper claw portion.

The milking claws and milking claw assemblies illustrated schematically in the various figures comprise several non-limiting examples. Other configurations are possible, depending upon the specific design parameters. With regard to the claw structures and pulsation block structures the embodiments illustrated schematically in FIGS. 1-10 are just some simple arrangements and obviously could take on additional forms including various claw portion shapes, lengths, widths, thicknesses, volumes, and the like. As those skilled in this art will readily appreciate, there are countless variations possible and the embodiments herein are simple and effective—but not necessarily optimized. The milk inlets (106, 108, 110, 112) as illustrated in the drawings are positioned generally tangentially to the upper claw portion. Although this tangential or generally tangential flow not necessary for all embodiments, it does have at least two benefits, one being that the milk circulates on internal geodesic lines of the internal surface of the upper milk claw, providing some cooling (perhaps 1, or 2, or 3° C.), and two, the milk is forced to impact upon the vertical partition 166, so that it does not matter how the pulsation block is operated (side-to-side, or front-to-back), the milk will enter the lower milk claw portion 102 and strike the vertical partition 166. This benefits in faster milking (higher capacity), for example for a typical, healthy dairy cow, less than 5 minutes, or less than 3 minutes, for completion of milking. This benefits in less stress for the animal and may reduce or prevent mastitis and/or other bacterial infections. Less stress translates into less release of hormones, such as adrenalin, which can counteract the positive role of oxytocin, a hormone that causes the mass of interconnecting blood vessels at the base of the teat to fill with blood, making the teat more erect and allowing milk to enter it from higher in the udder and pass through the teat. Oxytocin also encourages muscles throughout the udder to act to release milk. Most importantly, the muscle cells around the milk-producing alveoli deep in the udder contract and force the milk into the various ducts in the udder, down into the udder cistern and then into the teat cistern, ready for the milk to be removed by the suckling calf or the milking equipment.

Suitable metals for the metal pulsation blocks include stainless steels, for example, but not limited to, 304, 316, as well as titanium, titanium alloys, aluminum, aluminum alloys, copper, copper alloys, and the like. High-strength materials like C-110 and C-125 metallurgies that are NACE qualified may be employed. (As used herein, “NACE” refers to the corrosion prevention organization formerly known as the National Association of Corrosion Engineers, now operating under the name NACE International, Houston, Texas.) The skilled artisan, having knowledge of the particular application, temperatures, and available materials, will be able design the most cost effective, safe, and operable components for each particular application without undue experimentation.

In alternative embodiments, one or more of the various components may be ornamented with various ornamentation produced in various ways (for example stamping or engraving, or raised features such as reflectors, reflective tape), such as facility designs, operating company designs, logos, letters, words, nicknames (for example MADERO, and the like). Animal milking claws of the present disclosure may include optional hand-holds, which may be machined or formed to have easy-to-grasp features for fingers, or may have rubber grips shaped and adorned with ornamental features, such as raised knobby gripper patterns.

From the foregoing detailed description of specific embodiments, it should be apparent that patentable animal milking claws, assemblies, and methods have been described. Although specific embodiments of the disclosure have been described herein in some detail, this has been done solely for the purposes of describing various features and aspects of the apparatus and methods and is not intended to be limiting with respect to their scope. It is contemplated that various substitutions, alterations, and/or modifications, including but not limited to those implementation variations which may have been suggested herein, may be made to the described embodiments without departing from the scope of the appended claims.

What is claimed is:

1. An animal milking claw comprising:
a) an upper claw portion having an internal surface, and a lower claw portion, the upper claw portion having a first rear milk inlet, a second rear milk inlet, a first front milk inlet, a second front milk inlet, and the lower claw portion having a milk outlet and a vertical partition positioned along a longitudinal axis of the lower claw portion;
b) the milk inlets positioned generally tangentially to the upper claw portion and configured so that milk flows on geodesic curves on the internal surface of the upper milk claw, and the milk is forced to impact upon the vertical partition in the lower claw portion;
c) the milk outlet having a reinforced portion adjacent a location where the milk outlet connects to the lower claw portion and extending at least a portion of a length of the milk outlet, with one or more reinforcing chamfers positioned on each location where the reinforced portion of milk outlet connects with the lower claw portion.

2. The animal milking claw of claim 1 further comprising:
a) the first rear milk inlet having a reinforced portion adjacent a location where the first rear milk inlet connects to the upper claw portion and extending at least a portion of a length of the first rear milk inlet;
b) the second rear milk inlet having a reinforced portion adjacent a location where the second rear milk inlet connects to the upper claw portion and extending at least a portion of a length of the second rear milk inlet;
c) the first front milk inlet having a reinforced portion adjacent a location where the first front milk inlet connects to the upper claw portion and extending at least a portion of a length of the first front milk inlet; and
d) the second front milk inlet having a reinforced portion adjacent a location where the second front milk inlet connects to the upper claw portion and extending at least a portion of a length of the second front milk inlet.

4. The animal milking claw of claim 1 further comprising the lower claw portion including a girder having a distal end and reinforcing chamfers positioned on each side of the girder where the girder meets the lower claw portion, the distal end of the girder mating with a girder alignment clip.

5. An animal milking claw comprising:
a) an upper claw portion having an internal surface, and a lower claw portion, the upper claw portion having a first rear milk inlet, a second rear milk inlet, a first front milk inlet, a second front milk inlet, and the lower claw portion having a milk outlet and a vertical partition positioned along a longitudinal axis of the lower claw portion;
b) the milk inlets positioned generally tangentially to the upper claw portion and configured so that milk flows on geodesic curves on the internal surface of the upper milk claw, and the milk is forced to impact upon the vertical partition in the lower claw portion;
c) the first rear milk inlet having a reinforced portion adjacent a location where the first rear milk inlet connects to the upper claw portion and extending at least a portion of a length of the first rear milk inlet;
d) the second rear milk inlet having a reinforced portion adjacent a location where the second rear milk inlet connects to the upper claw portion and extending at least a portion of a length of the second rear milk inlet;
e) the first front milk inlet having a reinforced portion adjacent a location where the first front milk inlet connects to the upper claw portion and extending at least a portion of a length of the first front milk inlet; and
f) the second front milk inlet having a reinforced portion adjacent a location where the second front milk inlet connects to the upper claw portion and extending at least a portion of a length of the second front milk inlet.

6. The animal milking claw of claim 5 further comprising the milk outlet having a reinforced portion adjacent a location where the milk outlet connects to the lower claw portion and extending at least a portion of a length of the milk outlet, with one or more reinforcing chamfers positioned on each location where the reinforced portion of milk outlet connects with the lower claw portion.

7. The animal milking claw of claim 5 further comprising the lower claw portion including a girder having a distal end and reinforcing chamfers positioned on each side of the girder where the girder meets the lower claw portion, the distal end of the girder mating with a girder alignment clip.

8. An animal milking claw assembly comprising:
a) the animal milking claw of claim 1; and
b) a plastic pulsation block (116) connected to the upper claw portion, the plastic pulsation block having a first vacuum source connection (138), a second vacuum source connection (140), a first teat vacuum connection (142), a second teat vacuum connection (144), a third teat vacuum connection (146), and a fourth teat vacuum connection (148), the first and second teat vacuum connections positioned on a first side of the plastic pulsation block, the third and fourth teat vacuum connections positioned on a second side of the plastic pulsation block, the first, second, third, and fourth teat vacuum connections positioned in a plane, the first and second vacuum source connections positioned on a first end of the plastic pulsation block and also located in the plane.

9. The animal milking claw assembly of claim 8 further comprising:
a) the first rear milk inlet having a reinforced portion adjacent a location where the first rear milk inlet connects to the upper claw portion and extending at least a portion of a length of the first rear milk inlet;
b) the second rear milk inlet having a reinforced portion adjacent a location where the second rear milk inlet connects to the upper claw portion and extending at least a portion of a length of the second rear milk inlet;
c) the first front milk inlet having a reinforced portion adjacent a location where the first front milk inlet connects to the upper claw portion and extending at least a portion of a length of the first front milk inlet; and
d) the second front milk inlet having a reinforced portion adjacent a location where the second front milk inlet connects to the upper claw portion and extending at least a portion of a length of the second front milk inlet.

10. The animal milking claw assembly of claim 8 further comprising the lower claw portion including a girder (124) having a distal end (154) and reinforcing chamfers (136) positioned on each side of the girder where the girder meets the lower claw portion, the distal end of the girder mating with a girder alignment clip (134).

11. The milking claw assembly of claim 8 further comprising a partition (166) in the lower claw portion 104.

12. An animal milking claw assembly comprising:
a) the animal milking claw of claim 1; and
b) a coolant conduit (180) having a coolant fluid inlet (181) and a coolant fluid outlet (183), the coolant conduit positioned in close heat transfer contact with an exterior surface of a lower portion of the milk outlet conduit (114) and in spiral flow heat transfer contact with an exterior surface of the lower claw portion (104).

13. The animal milking claw assembly of claim 12 further comprising:
a plastic pulsation block (116) connected to the upper claw portion, the plastic pulsation block having a first vacuum source connection (138), a second vacuum source connection (140), a first teat vacuum connection (142), a second teat vacuum connection (144), a third teat vacuum connection (146), a fourth teat vacuum connection (148), the first and second teat vacuum connections positioned on a first side of the plastic pulsation block, the third and fourth teat vacuum connections positioned on a second side of the plastic pulsation block, the first, second, third, and fourth teat vacuum connections positioned in a plane, the first and second vacuum source connections positioned on a first end of the plastic pulsation block and also located in the plane, a connection flange (182), and a connecting bore (184).

14. The animal milking claw assembly of claim 12 further comprising:
a) the first rear milk inlet having a reinforced portion (126) adjacent a location where the first rear milk inlet connects to the upper claw portion and extending at least a portion of a length of the first rear milk inlet;
b) the second rear milk inlet having a reinforced portion (128) adjacent a location where the second rear milk inlet connects to the upper claw portion and extending at least a portion of a length of the second rear milk inlet;
c) the first front milk inlet having a reinforced portion (130) adjacent a location where the first front milk inlet connects to the upper claw portion and extending at least a portion of a length of the first front milk inlet; and
d) the second front milk inlet having a reinforced portion (132) adjacent a location where the second front milk inlet connects to the upper claw portion and extending at least a portion of a length of the second front milk inlet.

15. The animal milking claw assembly of claim 12 further comprising the lower claw portion including a girder (124) having a distal end (154) and reinforcing chamfers (136) positioned on each side of the girder where the girder meets the lower claw portion, the distal end of the girder mating with a girder alignment clip (134).

16. An animal milking claw assembly comprising:
a) the animal milking claw of claim 1; and
b) a 90-degree bracket (210) having a first (vertical) leg (212), a second (horizontal) leg (214), a through bore (215) in second leg (214), an arcuate slot (216) in first leg (212), and a generally linear slot (218) in first leg (212), the 90-degree bracket configured to secure a metal pulsation block to the upper claw portion (102).

17. An animal milking claw assembly comprising:
a) the animal milking claw of claim 1; and
b) a 90-degree bracket (210) having a first (vertical) leg (212), a second (horizontal) leg (214), a through bore (215) in second leg (214), an arcuate slot (216) in first leg (212), and a generally linear slot (218) in first leg (212), the second leg (214) of the 90-degree bracket (210) securing a metal pulsation block to the upper claw portion (102), the metal pulsation block having a first vacuum source conduit (220), a second vacuum source conduit (222), a first teat vacuum conduit (224), a second teat vacuum conduit (226), a third teat vacuum conduit (228), and a fourth teat vacuum conduit (230), the first and second teat vacuum conduits (224, 226) fluidly connected with the first vacuum source conduit and positioned on a first side of the metal pulsation block in a first plane, the third and fourth teat vacuum connections (228, 230) fluidly connected with the second vacuum source conduit and positioned on a second side of the metal pulsation block in a second plane parallel to the first plane, the first and second vacuum source connections positioned on a first end of the metal pulsation block located in a third plane perpendicular to the first and second planes, the first and second vacuum source connections extending through the generally linear slot (218), and a connecting plate (232) connecting the first vacuum source conduit (220) with the second vacuum source conduit (222).

18. An animal milking claw assembly comprising:
a) the animal milking claw of claim 1; and
b) a 90-degree bracket (210) having a first (vertical) leg (212), a second (horizontal) leg (214), a through bore (215) in second leg (214), an arcuate slot (216) in first leg (212), and a generally linear slot (218) in first leg (212), the second leg (214) of the 90-degree bracket (210) securing a metal pulsation block to the upper claw portion (102), the metal pulsation block having a first alternate vacuum source conduit (240), a second alternate vacuum source conduit (242), a first teat alternate vacuum conduit (244), a second teat alternate vacuum conduit (246), a third teat alternate vacuum conduit (248), and a fourth teat alternate vacuum conduit (250), the first and third teat alternate vacuum conduits (244, 248) fluidly connected with the first alternate vacuum source conduit (240) and positioned on a first side of the metal pulsation block in a first plane, the second and fourth teat alternate vacuum connections (246, 250) fluidly connected with the second alternate vacuum source conduit (242) and positioned on a second side of the metal pulsation block in a second plane parallel to the first plane, the first and second alternate vacuum source connections positioned on a first end of the metal pulsation block located in a third plane perpendicular to the first and second planes, the first and second vacuum source connections extending through the generally linear slot (218), and a connecting plate (252) connecting the first alternate vacuum source conduit (240) with the second alternate vacuum source conduit (242).

19. An animal milking claw assembly comprising:
a) the animal milking claw of claim 1; and
b) a metal pulsation block (264) connected to the upper claw portion, the metal pulsation block having a first metal vacuum source connection (274), a second metal vacuum source connection (276), a first teat metal vacuum connection (278), a second teat metal vacuum connection (280), a third teat metal vacuum connection (282), and a fourth teat metal vacuum connection (284), the first and second teat metal vacuum connections positioned on a first side of the metal pulsation block, the third and fourth teat metal vacuum connections positioned on a second side of the metal pulsation block, the first, second, third, and fourth teat metal vacuum connections positioned in a plane, the first and second metal vacuum source connections positioned on a first end of the metal pulsation block and also located in the plane.

20. The animal milking claw assembly of claim 19 further comprising a shackle (260) connected to a metal cap (262), the metal cap integral with a metal connecting rod (194), a nut (266) threaded onto a distal end of the metal connecting rod (194).

21. An animal milking claw assembly comprising:
a) the animal milking claw of claim 1;
b) a metal bracket (292) having a first portion (296), a second portion (298) connected to and generally perpendicular to the first portion, a third portion (302) connected to the second portion and angled to the second portion at an angle α ranging from about 120 to about 160 degrees, and fourth portion (304) connected to the third portion and angled to the third portion at an angle β ranging from about 130 to about 160 degrees, with a through hole (306) in the fourth portion (304); and
c) the metal bracket (292) securing a metal pulsation block (294) to the upper claw portion (102), the metal pulsation block having a front metal vacuum source conduit (312), a rear metal vacuum source conduit (314), a first front teat metal vacuum conduit (308), a second front teat metal vacuum conduit (310), a first rear teat metal vacuum conduit (316), and a second rear teat metal vacuum conduit (318), the first and second front teat metal vacuum conduits (308, 310) fluidly connected with the front metal vacuum source conduit (312) and forming a front-facing U-shaped end of the metal pulsation block (294), the first and second rear teat metal vacuum conduits (316, 318) fluidly connected with the rear metal vacuum source conduit (314) and forming a rear-facing U-shaped end of the metal pulsation block (294), the first and second front teat metal vacuum source connections (308, 310) extending around the second portion (298) of the metal bracket (292), and a connecting plate (320) connecting the front-facing U-shaped end with the rear-facing U-shaped end.

22. A method of using the animal milking claw assembly of claim 8 to perform a milking procedure on an animal, the method comprising:
a) selecting a material for a pulsation block, the material selected from metal and plastic;
b) selecting a configuration for the pulsation block selected from front to back and side to side configurations;
c) optionally providing a coolant conduit with coolant flow therein in heat transfer contact with an external surface of the milk outlet, the lower milking claw portion, or both;
d) fitting the milk inlets to hoses and teat cups, and connecting the teat cups to an animal's teats; and
e) initiating a milking procedure on the animal.
